(19) United States
(12) Patent Application Publication
(10) Pub. No.: US 2026/0043747 A1
(43) Pub. Date: Feb. 12, 2026

(54) APPARATUS FOR INSPECTING DEFECT AND METHOD THEREOF

(71) Applicant: INTIMAX INC., Seongnam-si (KR)

(72) Inventors: Dae Il PARK, Anyang-si (KR); Youngjae CHOI, Gwangmyeong-si (KR)

(73) Assignee: INTIMAX INC., Seongnam-si (KR)

(21) Appl. No.: 19/274,990

(22) Filed: Jul. 21, 2025

(30) Foreign Application Priority Data
Aug. 7, 2024 (KR) 10-2024-0105053

(51) Int. Cl. G01N 21/88; G01N 21/95; G06T 7/00; G06T 7/593

(52) U.S. Cl. CPC G01N 21/8851; G01N 21/951; G06T 7/0004; G06T 7/593; G01N 2021/889; G06T 2207/10028; G06T 2207/20081; G06T 2207/20084; G06T 2207/30224

(57) ABSTRACT

Disclosed is a defect inspecting apparatus including a memory that stores computer-executable instructions, and at least one processor that executes the instructions by accessing the memory. The at least one processor obtains a first feature point and a second feature point, which serve as a basis for rotation of a solid shape, from an input image associated with the solid shape targeted for defect inspection, obtains a target image, in which the first feature point and the second feature point are included in a predetermined area, by rotating the solid shape based on the first feature point and the second feature point, and obtains information about whether the solid shape has a defect, by applying the target image to a defect inspection model.

### CROSS-REFERENCE TO RELATED APPLICATION

This application claims the benefit of priority to Korean Patent Application No. 10-2024-0105053, filed in the Korean Intellectual Property Office on Aug. 7, 2024, the entire contents of which are incorporated herein by reference.

### TECHNICAL FIELD

The present disclosure relates to a defect inspecting apparatus and a method thereof, and more particularly, relates to a technology for performing defect inspection of a spherical object.

### BACKGROUND

The surface quality of a spherical object, especially a golf ball, has a direct impact on its performance and durability. Accordingly, it is very important to accurately and efficiently detect surface defects during a manufacturing process. A representative method for inspecting defects that occur on the surface of a spherical object is a non-destructive inspection method. For example, technologies such as X-rays, ultrasound, or thermal imaging are applied to the non-destructive inspection method that may inspect a product without damaging it.

The non-destructive inspection method may increase inspection costs because it may be performed through inspection equipment. Accordingly, to avoid additional inspection costs and to perform efficient inspection methods, inspection methods based on optical technology and artificial intelligence are required. In particular, with the development of high-resolution cameras and precision optical systems, even minute surface defects may be detected. Moreover, with the development of computer vision and artificial intelligence, complex pattern recognition and defect classification are now possible through image processing algorithms and machine learning technologies. However, for inspection methods based on optical technologies and artificial intelligence, a method of acquiring a base image (or input image) may be based on a method of consistently aligning a spherical object.

To solve these issues, it is necessary to develop a technology of consistently aligning a spherical object and a technology of inspecting defects in the spherical object based on the image of the aligned spherical object.

### SUMMARY

The present disclosure has been made to solve the above-mentioned problems occurring in the prior art while advantages achieved by the prior art are maintained intact.

An aspect of the present disclosure provides a defect inspecting apparatus that obtains whether a solid shape has a defect, by applying a target image, which is obtained by rotating a solid shape based on an input image of a solid shape to be subject to defect inspection, to a defect inspection model, thereby reducing the possibility that a minute surface defect may affect a trajectory, along which the solid shape moves, through precise inspection, and a method thereof.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a defect inspecting apparatus includes a memory that stores computer-executable instructions, and at least one processor that executes the instructions by accessing the memory. The at least one processor obtains a first feature point and a second feature point, which serve as a basis for rotation of a solid shape, from an input image associated with the solid shape targeted for defect inspection, obtains a target image, in which the first feature point and the second feature point are included in a predetermined area, by rotating the solid shape based on the first feature point and the second feature point, and obtains information about whether the solid shape has a defect, by applying the target image to a defect inspection model.

In an embodiment, the at least one processor may obtain a virtual shape, in which the solid shape is expressed in three dimensions, by projecting the input image into a target coordinate space including a first axis, a second axis, and a third axis, which are perpendicular to each other, an origin of the virtual shape being the same as an origin of the target coordinate space, may obtain first feature point coordinates and second feature point coordinates respectively corresponding to coordinates of the first feature point and the second feature point based on the virtual shape and the solid shape, and may rotate the solid shape through a programmable logic controller (PLC) output obtained by rotating the virtual shape based on the first feature point coordinates and the second feature point coordinates.

In an embodiment, the at least one processor may obtain a first plane passing through the first feature point coordinates, the second feature point coordinates, and the origin of the virtual shape, may obtain an intersection that the first plane and a second plane have in common, and first sub-coordinates located on a surface of the virtual shape, wherein the second plane is determined based on the first axis and the second axis, and may perform first rotation of the virtual shape such that the first sub-coordinates are located on the first axis.

In an embodiment, the at least one processor may rotate the virtual shape such that the first sub-coordinates are located on an axis perpendicular to the second plane, the axis perpendicular to the second plane including the third axis, may obtain second sub-coordinates, which are a point located on the second plane among points included in common in the first plane and the surface of the virtual shape, and may perform second rotation of the virtual shape such that the second sub-coordinates are located on the second axis.

In an embodiment, the at least one processor may rotate the virtual shape by a predetermined angle based on the second axis, may obtain third sub-coordinates associated with a point having the same distance from each of the first feature point coordinates and the second feature point coordinates from among points included in common in the first plane and the surface of the virtual shape, and may perform third rotation of the virtual shape such that the third sub-coordinates are located on the second axis.

In an embodiment, the at least one processor may determine whether the first feature point coordinates and the second feature point coordinates are included in a target area, from the virtual shape where the third sub-coordinates are located on the second axis, wherein the target area includes an area corresponding to the predetermined area in the target coordinate space, and may obtain the target image centered on the second axis from the virtual shape when the first feature point coordinates and the second feature point coordinates are included in the target area.

In an embodiment, the at least one processor may obtain a first image associated with a surface of the solid shape based on a first rotation axis extending from a center of the solid shape, may obtain a second image associated with the surface of the solid shape based on a second rotation axis perpendicular to the first rotation axis, and may obtain the input image by combining the first image and the second image.

In an embodiment, the defect inspection model may include a neural network pre-learned to extract a defect in a target included in an image from an image thus input.

In an embodiment, the solid shape may include a spherical object, and the first feature point and the second feature point may include a mark included on a surface of the spherical object.

According to an aspect of the present disclosure, a defect inspecting method includes obtaining a first feature point and a second feature point, which serve as a basis for rotation of a solid shape, from an input image associated with the solid shape targeted for defect inspection, obtaining a target image, in which the first feature point and the second feature point are placed in a predetermined area, by rotating the solid shape based on the first feature point and the second feature point, and obtaining information about whether the solid shape has a defect, by applying the target image to a defect inspection model.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram illustrating a defect inspecting apparatus, according to an embodiment of the present disclosure;

FIG. 2 is a flowchart for describing a defect inspecting method, according to an embodiment of the present disclosure;

FIG. 3 is a flowchart for describing a method for rotating a solid shape in a defect inspecting apparatus, according to an embodiment of the present disclosure;

FIG. 4 is a flowchart for describing a method for performing a defect inspection of a solid shape, on which rotation is performed, in a defect inspecting apparatus, according to an embodiment of the present disclosure;

FIG. 5 is a drawing illustrating an example of a virtual shape in which a solid shape is expressed three-dimensionally, according to an embodiment of the present disclosure;

FIG. 6 is a diagram illustrating an example of feature point coordinates, according to an embodiment of the present disclosure;

FIG. 7 is a drawing illustrating an example of an intersection that a first plane and a second plane have in common, according to an embodiment of the present disclosure;

FIG. 8 is a diagram illustrating an example of first sub-coordinates, according to an embodiment of the present disclosure;

FIG. 9 is a diagram illustrating an example of first rotation of a virtual shape, according to an embodiment of the present disclosure;

FIG. 10 is a diagram illustrating an example of second sub-coordinates, according to an embodiment of the present disclosure;

FIG. 11 is a diagram illustrating an example of second rotation of a virtual shape, according to an embodiment of the present disclosure;

FIG. 12 is a diagram illustrating an example of third sub-coordinates, according to an embodiment of the present disclosure;

FIG. 13 is a diagram illustrating an example of third rotation of a virtual shape, according to an embodiment of the present disclosure;

FIG. 14 is a diagram illustrating an example of a target image, according to an embodiment of the present disclosure;

FIG. 15 is a drawing illustrating an example of rotation of a solid shape based on the virtual shapes of FIGS. 5 to 13, according to an embodiment of the present disclosure;

FIG. 16 is a diagram illustrating an example of an interface for setting an area applied to an input image in a first image or a second image;

FIG. 17 is a diagram illustrating an example of an interface for obtaining feature points from a first image or a second image;

FIGS. 18 and 19 are diagrams showing examples of interfaces for converting a first image or a second image into a spherical image;

FIG. 20 is a diagram illustrating an example of an interface for obtaining an input image based on a first image and a second image;

FIG. 21 is a diagram illustrating an example of an interface that receives an input for rotating a virtual shape corresponding to an input image;

FIG. 22 is a diagram showing an example of an interface that outputs a target image;

FIG. 23 is a diagram illustrating an example of an interface for generating learning data of a feature point identification model that identifies a feature point from an input image; and

FIG. 24 is a diagram illustrating a computing system associated with a defect inspecting apparatus or a defect inspecting method, according to an embodiment of the present disclosure.

With regard to description of drawings, the same or similar components will be marked by the same or similar reference signs.

### DETAILED DESCRIPTION

Hereinafter, some embodiments of the present disclosure will be described in detail with reference to the accompanying drawings. In adding reference numerals to components of each drawing, it should be noted that the same components include the same reference numerals, although they are indicated on another drawing. Furthermore, in describing the embodiments of the present disclosure, detailed descriptions associated with well-known functions or configurations will be omitted when they may make subject matters of the present disclosure unnecessarily obscure. Hereinafter, various embodiments of the present disclosure may be described with reference to accompanying drawings. Accordingly, those of ordinary skill in the art will recognize that modification, equivalent, and/or alternative on the various embodiments described herein may be variously made without departing from the scope and spirit of the present disclosure. With regard to description of drawings, similar components may be marked by similar reference numerals.

In describing elements of an embodiment of the present disclosure, the terms first, second, A, B, (a), (b), and the like may be used herein. These terms are only used to distinguish one element from another element, but do not limit the corresponding elements irrespective of the nature, order, or priority of the corresponding elements. Furthermore, unless otherwise defined, all terms used herein, including technical or scientific terms, include the same meaning as commonly understood by one of ordinary skill in the technical field to which the present disclosure belongs. It will be understood that terms used herein should be interpreted as including a meaning that is consistent with their meaning in the context of the present disclosure and the relevant art and will not be interpreted in an idealized or overly formal sense unless expressly so defined herein. For example, the terms, such as “first”, “second”, and the like used herein may refer to various elements of various embodiments of the present disclosure, but do not limit the elements. For example, “a first user device” and “a second user device” may indicate different user devices regardless of the order or priority thereof. For example, without departing the scope of the present disclosure, a first component may be referred to as a second component, and similarly, a second component may be referred to as a first component.

In this specification, the expressions “possess”, “may possess”, “include” and “comprise”, or “may include” and “may comprise” used herein indicate existence of corresponding features (e.g., elements such as numeric values, functions, operations, or components) but do not exclude presence of additional features.

It will be understood that when an element (e.g., a first element) is referred to as being “(operatively or communicatively) coupled with/to” or “connected to” another element (e.g., a second element), it may be directly coupled with/to or connected to the other element or an intervening element (e.g., a third element) may be present. In contrast, when an element (e.g., a first element) is referred to as being “directly coupled with/to” or “directly connected to” another element (e.g., a second element), it should be understood that there are no intervening element (e.g., a third element).

According to the situation, the expression “configured to” used herein may be used as, for example, the expression “suitable for”, “including the capacity to”, “designed to”, “adapted to”, “made to”, or “capable of”.

The term “configured to” must not mean only “specifically designed to” in hardware. Instead, the expression “a device configured to” may mean that the device is “capable of” operating together with another device or other components. For example, a “processor configured to (or set to) perform A, B, and C” may mean a dedicated processor (e.g., an embedded processor) for performing a corresponding operation or a generic-purpose processor (e.g., a central processing unit (CPU) or an application processor) which performs corresponding operations by executing one or more software programs which are stored in a memory device. The terms used in the specification are only used to describe a specific embodiment and are not intended to limit the scope of the present disclosure. The terms of a singular form may include plural forms unless otherwise specified. All the terms used herein, which include technical or scientific terms, may include the same meaning that is generally understood by a person skilled in the art. It will be further understood that terms, which are defined in a dictionary and commonly used, should also be interpreted as is customary in the relevant related art and not in an idealized or overly formal meaning unless expressly so defined herein in various embodiments of the present disclosure. In some cases, even though terms are terms which are defined in the specification, they may not be interpreted to exclude embodiments of the present disclosure.

In the present disclosure disclosed herein, the expressions “A or B”, “at least one of A or/and B”, or “one or more of A or/and B”, and the like used herein may include any and all combinations of one or more of the associated listed items. For example, the term “A or B”, “at least one of A and B”, or “at least one of A or B” may refer to all of the case (1) where at least one A is included, the case (2) where at least one B is included, or the case (3) where both of at least one A and at least one B are included. Moreover, in describing a component of an embodiment of the present disclosure, the expressions at least one of “A or B”, “at least one of A and B”, “at least one of A or B”, “A, B, or C”, “at least one of A, B, and C”, or “at least one of A, B, or C, or any combination thereof” may include any and all combinations of one or more of the associated listed items. In particular, expressions “at least one of A, B, or C, or any combination thereof” may include A, B, or C, or any combination thereof such as AB, ABC, or the like.

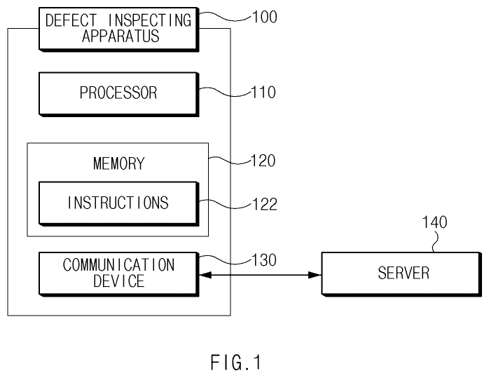

Hereinafter, various embodiments of the present disclosure will be described in detail with reference to FIGS. 1 to 24.

FIG. 1 is a block diagram illustrating a defect inspecting apparatus, according to an embodiment of the present disclosure.

A defect inspecting apparatus 100 according to an embodiment may include a processor 110, a memory 120 including instructions 122, and a communication device 130.

The defect inspecting apparatus 100 may represent a device for inspecting defects in a solid shape. For example, the defect inspecting apparatus 100 may obtain an image of the solid shape. The defect inspecting apparatus 100 may obtain a virtual shape by performing a three-dimensional transformation of the obtained image. The defect inspecting apparatus 100 may obtain a PLC output associated with the rotation of the solid shape by rotating the virtual shape. The defect inspecting apparatus 100 may rotate a solid shape based on the PLC output. The defect inspecting apparatus 100 may obtain the image of the solid shape in which rotation is performed. The defect inspecting apparatus 100 may obtain information about whether the solid shape has a defect, by applying the obtained image to a defect inspection model.

The defect inspecting apparatus 100 may obtain an image, in which feature points of the solid shape are included and/or located in a predetermined area, regardless of the placement state of the solid shape before performing the rotation, by performing the rotation of the solid shape. For example, when a feature point of the solid shape is at a first location, the defect inspecting apparatus 100 may locate the feature point at the first location in a predetermined area by performing a rotation of the solid shape. When the feature point of the solid shape is at a second location different from the first location, the defect inspecting apparatus 100 may locate the feature point at the second location in a predetermined area by rotating the solid shape. Here, the predetermined area may be an area including a lens of a camera or a shooting device that photographs the solid shape on which the rotation is performed.

The defect inspecting apparatus 100 may obtain an image including a feature point without changing the location of the shooting device that photographs the solid shape, by including and/or locating the feature point of the solid shape in a predetermined area through rotation of the solid shape. The defect inspecting apparatus 100 may obtain information about whether the solid shape has a defect, by applying an image including the feature point to the defect inspection model.

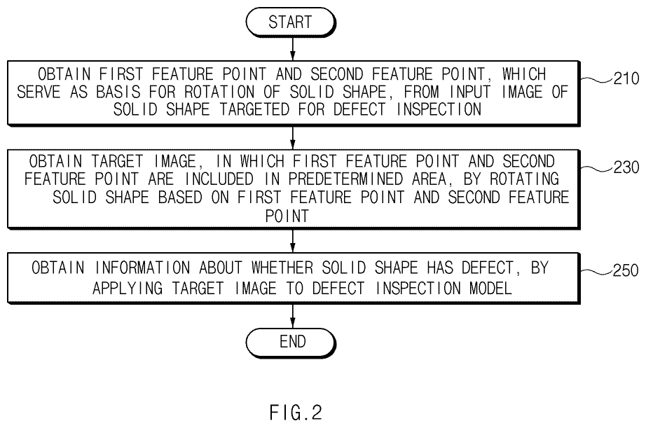

Hereinafter, detailed descriptions of the solid shape, solid shape feature points, and defect inspection model are given later with reference to FIG. 2.

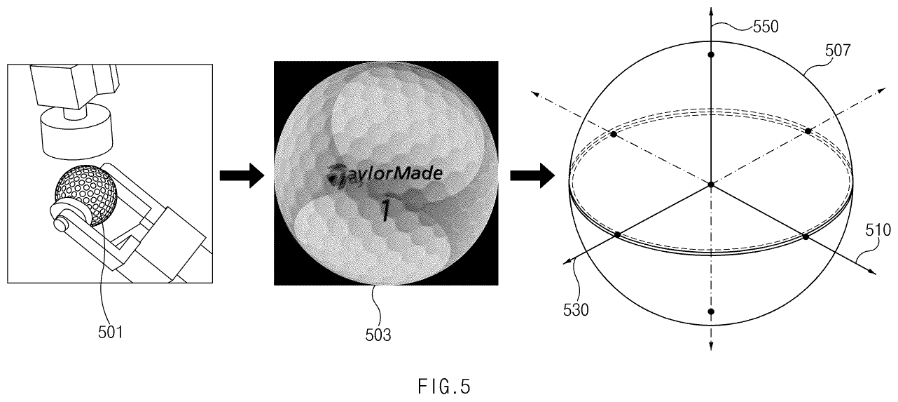

Detailed descriptions of a method for rotating a virtual shape for rotation of a solid shape are given in detail with reference to FIGS. 5 to 14 below.

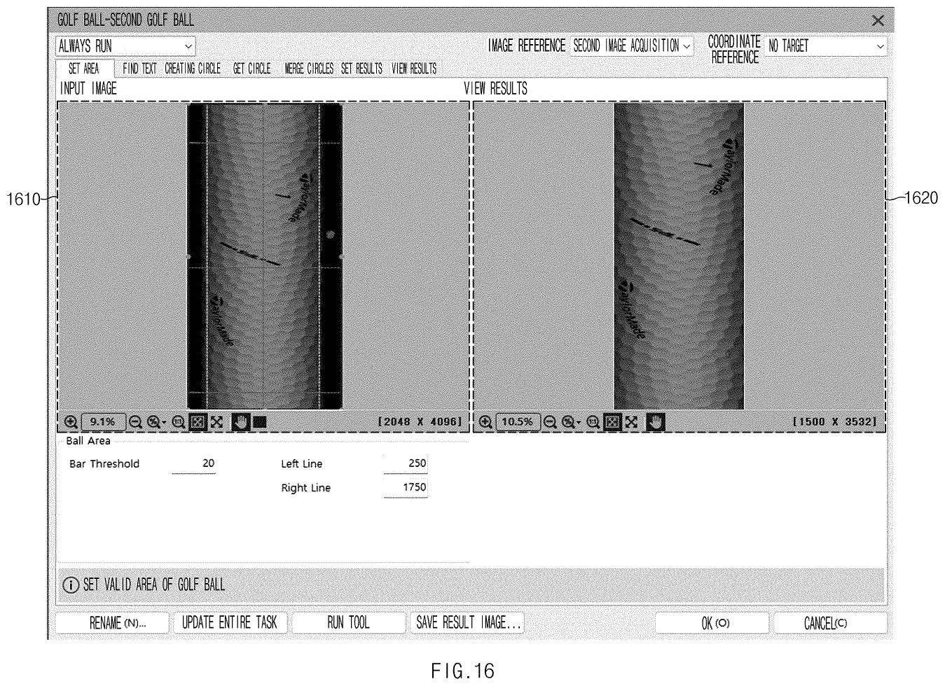

Examples of interfaces that the defect inspecting apparatus 100 may provide to a user and/or inspection equipment performing defect inspection of a solid shape are described in detail with reference to FIGS. 16 to 23 below.

The processor 110 may execute software and may control at least one other component (e.g., a hardware or software component) connected to the processor 110. The processor 110 may also perform various data processing or operations. For example, the processor 110 may store a solid shape, a virtual shape, or a feature point in the memory 120.

For reference, the processor 110 may perform all operations performed by the defect inspecting apparatus 100. Therefore, for convenience of description in this specification, an operation performed by the defect inspecting apparatus 100 is mainly described as an operation performed by the processor 110. Furthermore, for convenience of description in this specification, the processor 110 is mainly described as a single processor, but it is not limited thereto. For example, the defect inspecting apparatus 100 may include at least one processor. The at least one processor may perform all operations associated with defect inspection operations of a solid shape.

The memory 120 may temporarily and/or permanently store various pieces of data and/or information required to perform the defect inspection operations of a solid shape. For example, the memory 120 may store a solid shape, a virtual shape, or a feature point.

The communication device 130 may support communication between the defect inspecting apparatus 100 and a server 140. For example, the communication device 130 may include one or more components for communicating between the defect inspecting apparatus 100 and the server 140. For example, the communication device 130 may include a short-range wireless communication device, a microphone, or the like. In this case, short-range communication technologies include wireless LAN (Wi-Fi), Bluetooth, ZigBee, Wi-Fi Direct (WFD), ultra-wideband (UWB), infrared data association (IrDA), Bluetooth Low Energy (BLE), and near field communication (NFC), and the like, but are not limited thereto.

The defect inspecting apparatus 100 may receive data associated with a solid shape from the server 140 through the communication device 130. In detail, the defect inspecting apparatus 100 may transmit a PLC output or may receive an image of the solid shape, from the server 140 through the communication device 130.

FIG. 2 is a flowchart for describing a defect inspecting method, according to an embodiment of the present disclosure.

According to an embodiment, in operation 210, a processor (e.g., the processor 110 of FIG. 1) may obtain a first feature point and a second feature point, which serve as a basis for rotation of a solid shape, from an input image associated with the solid shape targeted for defect inspection.

The solid shape may represent a spherical object that exists in real space. For example, the solid shape may include at least one of a golf ball, a ping-pong ball, a baseball, or a soccer ball, or any combination thereof.

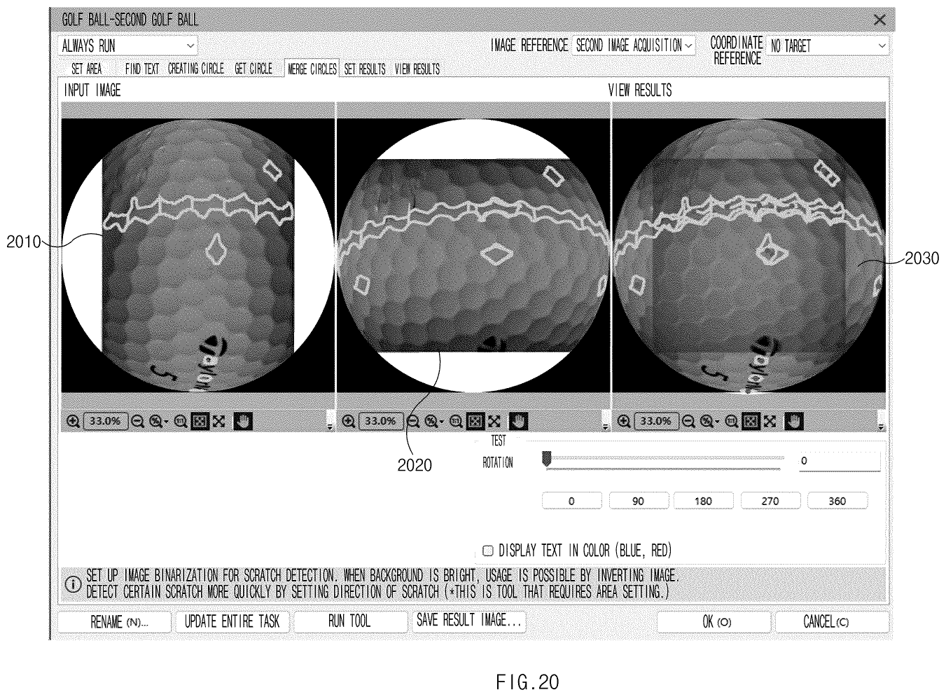

The input image may represent an image obtained by rotating the solid shape around a single imaginary axis passing through the solid shape. For example, the input image may be determined based on a first image obtained by rotating the solid shape around a first imaginary axis passing through the solid shape, and a second image obtained by rotating the solid shape around a second axis, which is perpendicular to the first axis and which passes through the solid shape. Detailed descriptions of a method for obtaining an input image will be given with reference to FIG. 20 below.

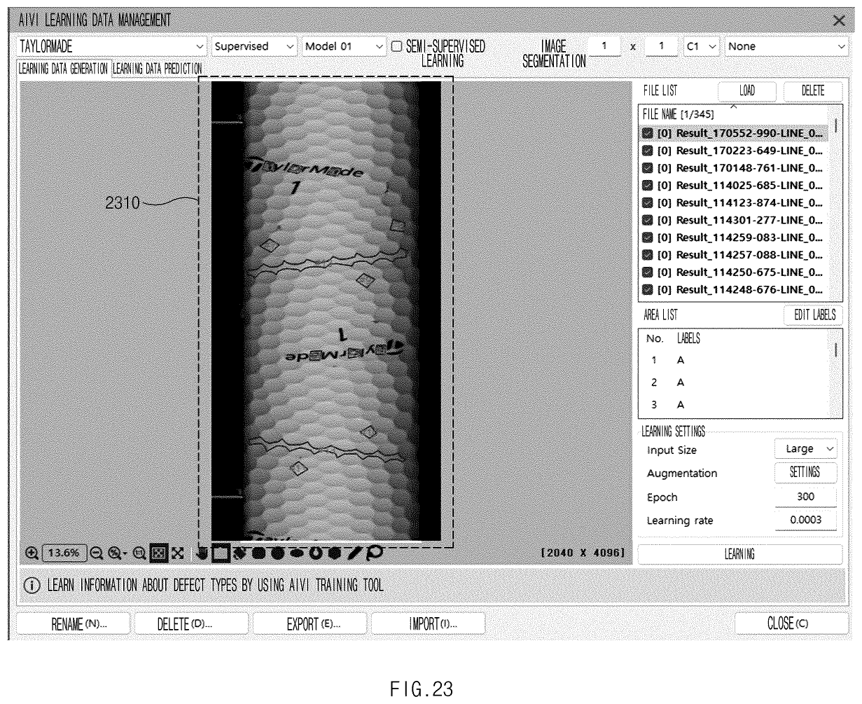

The feature point may include a mark included on the surface of the solid shape (e.g., a spherical object). For example, the feature point may include at least one of a mark, a trace, or text, or any combination thereof included in the surface of a spherical object. For example, when there is text ‘ABCD’ on the surface of a spherical object, at least one of ‘A’, ‘B’, ‘C’, or ‘D’, or any combination thereof may be the feature point. In this specification, for convenience of description, it is described that the first feature point includes the leftmost text among the texts on the surface of the spherical object, and the second feature point includes the rightmost text among the texts on the surface of the spherical object. Detailed descriptions of a method in which a processor identifies or detects a feature point will be given with reference to FIG. 23 below.

In operation 230, the processor may obtain a target image, in which the first feature point and the second feature point are included in a predetermined area, by rotating a solid shape based on the first feature point and the second feature point.

The target image may represent an image of a solid shape on which rotation is performed. For example, when the processor performs the rotation of a solid shape, the placement state of the solid shape may include a state where the first feature point and the second feature point are located in a predetermined area. In other words, when the rotation is performed by the processor, the solid shape in a state where the first feature point and the second feature point are not located in a predetermined area may be in a state where the first feature point and the second feature point are located in a predetermined area.

In detail, the target image may include a two-dimensional (2D) image obtained by capturing a solid shape on which the rotation is performed. The 2D image may not include all the surfaces of a three-dimensional (3D) solid shape. In particular, the feature point of the solid shape may be located on the back and/or rear surface from the perspective of the lens photographing the solid shape. Accordingly, it is a need for an operation of rotating the solid shape such that the feature point of the solid shape is located in a predetermined area from the perspective of the lens photographing the solid shape.

In operation 250, the processor may obtain information about whether the solid shape has a defect, by applying the target image to a defect inspection model. For example, the information about whether the solid shape has a defect may include whether at least one of a scratch, a dent, a paint chipping, a crack, a surface irregularity, discoloration, or a dimple damage, or any combination thereof occurs and/or is found on the surface of the solid shape.

The defect inspection model may include a neural network learned to extract defects in a target (e.g., a solid shape) included in an image from an input image.

The processor may learn the defect inspection model. For example, the defect inspection model may include a neural network. The neural network may include a plurality of layers, and each layer may include a plurality of nodes. The node may include a node value determined based on an activation function. A node on any layer may be connected to a node (e.g., another node) on another layer through a link (e.g., a connection edge) with a connection weight. The node value of a node may be propagated to other nodes through the link. In an inference operation of the neural network, node values may be forward propagated from the previous layer to the next layer.

For example, the forward propagation operation in the defect inspection model may indicate an operation of propagating node values based on input data in a direction from an input layer of the defect inspection model to an output layer. In other words, the node value of the corresponding node may be propagated (e.g., forward propagated) to a node (e.g., the next node) of the next layer connected to the node through the connection edge. For example, the node may receive a value weighted by a connection weight from the previous node (e.g., a plurality of nodes) connected through the connection edge.

The node value of a node may be determined based on applying an activation function to the sum (e.g., weighted sum) of weighted values received from previous nodes. For example, a parameter of a neural network may include the connection weight described above. The parameters of the neural network may be updated such that a value of an objective function value described later changes in a targeted direction (e.g., a direction in which a loss is minimized).

The learned defect inspection model may indicate a model learned through machine learning, and may be the learned machine learning model that outputs a training output (e.g., information about whether a solid shape has a defect) from a training input (e.g., a target image).

The machine learning model (e.g., the learned defect inspection model) may be created through machine learning. For example, the learning algorithm may include supervised learning, unsupervised learning, semi-supervised learning, or reinforcement learning, but is not limited to the above example.

The machine learning model may include a plurality of artificial neural network layers. The artificial neural network may be one of a deep neural network (DNN), a convolutional neural network (CNN), U-Net for image segmentation (U-net), a recurrent neural network (RNN), a restricted Boltzmann machine (RBM), a deep belief network (DBN), a bidirectional recurrent deep neural network (BRDNN), or a deep Q-network, or at least one combination among combinations thereof, but may not be limited to the above-described example.

In the case of supervised learning, the above-described machine learning model may be trained based on training data including pairs of a training input and a training output mapped to the training input. For example, the machine learning model may be trained to output the training output from the training input. The machine learning model during training may generate a temporary output in response to the training input, and may be trained such that the loss between the temporary output and the training output (e.g., a training target) is minimized. During a training process, a parameter (e.g., a connection weight between nodes/layers in a neural network) of the machine learning model may be updated depending on the loss. For example, the learning may be performed in the defect inspecting apparatus (e.g., the defect inspecting apparatus 100 of FIG. 1), in which a machine learning model is performed, or may be performed through a separate server (e.g., the server 140 of FIG. 1). The machine learning model (e.g., the trained defect inspection model) in which training is completed may be stored in a memory (e.g., the memory 120 in FIG. 1).

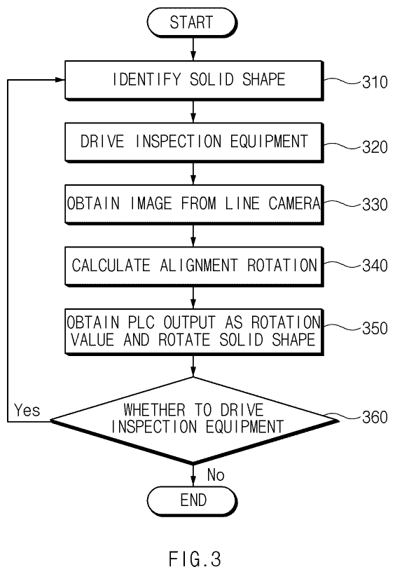

FIG. 3 is a flowchart for describing a method for rotating a solid shape in a defect inspecting apparatus, according to an embodiment of the present disclosure.

According to an embodiment, in operation 310, a processor (e.g., the processor 110 of FIG. 1) may identify a solid shape. For example, a processor may identify at least one of the shape of a solid shape, the type of a solid shape, or the state of the solid shape, or any combination thereof.

In operation 320, the processor may drive inspection equipment. For example, the inspection equipment may include at least one camera to photograph the solid shape. The inspection equipment may capture the solid shape by using each camera. The inspection equipment may be located within a defect inspecting apparatus (e.g., the defect inspecting apparatus 100 of FIG. 1) or may exist separately from the defect inspecting apparatus.

In operation 330, the processor may obtain an image from a line camera. For example, the line camera may represent a camera equipped on inspection equipment. The processor may generate and/or obtain an input image based on the obtained image.

In operation 340, the processor may calculate alignment rotation. For example, the alignment rotation may represent a rotation for aligning a solid shape. For example, the processor may rotate the solid shape according to the calculated alignment rotation value.

In operation 350, the processor may obtain a programmable logic controller (PLC) output as a rotation value and may rotate the solid shape. For example, the processor may rotate a solid shape through a PLC output obtained by rotating a virtual shape based on first feature point coordinates and second feature point coordinates.

In operation 360, the processor may determine whether to drive the inspection equipment. When the inspection equipment is running, the processor may perform operation 310. On the other hand, the processor may be terminated when the inspection equipment is not running.

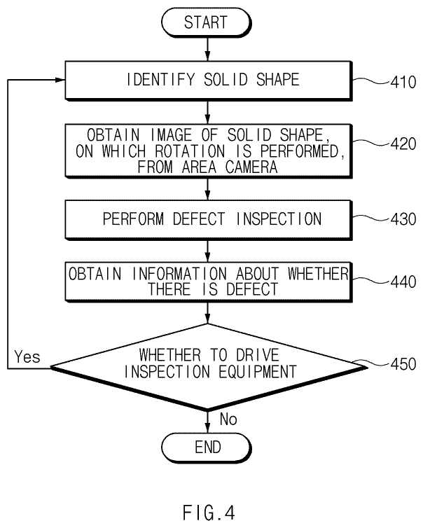

FIG. 4 is a flowchart for describing a method for performing a defect inspection of a solid shape, on which rotation is performed, in a defect inspecting apparatus, according to an embodiment of the present disclosure.

According to an embodiment, in operation 410, a processor (e.g., the processor 110 of FIG. 1) may identify a solid shape. Here, the solid shape may be a solid shape on which rotation is performed by the PLC output described in FIG. 3. The rotation by the PLC output may be performed at least once.

In operation 420, the processor may obtain an image of a solid shape, on which rotation is performed, from an area camera. For example, the area camera may represent a camera equipped on inspection equipment. The processor may generate and/or obtain a target image based on the obtained image.

In operation 430, the processor may perform defect inspection. For example, the processor may perform defect inspection of a solid shape based on an image (e.g., a target image) captured by the area camera.

In operation 440, the processor may obtain information about whether there is a defect. For example, the processor may obtain information about whether the solid shape has a defect, by applying the target image to a defect inspection model.

In operation 450, the processor may determine whether to drive the inspection equipment. When the inspection equipment is running, the processor may perform operation 410. On the other hand, the processor may be terminated when the inspection equipment is not running.

FIG. 5 is a drawing illustrating an example of a virtual shape in which a solid shape is expressed three-dimensionally, according to an embodiment of the present disclosure.

According to an embodiment, a processor (e.g., the processor 110 of FIG. 1) may rotate a virtual shape 507 based on an input image 503 to rotate a solid shape 501. The processor may rotate the solid shape 501 based on a PLC output obtained by rotating the virtual shape 507.

For example, the solid shape 501 may be a three-dimensional object that may be located in real coordinate space. In detail, the real coordinate space may be a space where a defect inspecting apparatus (e.g., the defect inspecting apparatus 100 of FIG. 1) is present, and may represent a physical real space.

For example, the input image 503 may include the solid shape 501, which is a three-dimensional object, two-dimensionally expressed.

For example, the virtual shape 507 may be located in a target coordinate space in a three-dimensional form. In detail, the target coordinate space may represent a virtual space. In particular, the target coordinate space may represent a space where the real coordinate space is abstracted. The virtual shape 507 is a three-dimensional shape generated based on the input image 503 and may correspond to the solid shape 501. For reference, the processor may generate the virtual shape 507 from the solid shape 501. However, an operation of directly generating the virtual shape 507 from the solid shape 501 requires a separate camera for obtaining the three-dimensional object. Accordingly, the processor may obtain at least two images from the solid shape 501 without a separate camera, may generate the input image 503 based on the two obtained images, and may generate the virtual shape 507 based on the generated input image 503.

For example, a change in the target coordinate space may be described as a change in the real coordinate space. In detail, the rotation of the virtual shape 507 located in the target coordinate space may correspond to the rotation of the solid shape 501 located in the real coordinate space.

For example, when the virtual shape 507 in the target coordinate space is rotated by a first angle in the first direction with respect to an axis passing through the origin of the virtual shape 507, the solid shape 501 in the real coordinate space may be rotated by the first angle in the first direction with respect to the axis passing through the origin of the solid shape 501.

In this specification, for convenience of description, the real coordinate space and the target coordinate space are described as corresponding spaces, and a change in the virtual shape 507 is described as corresponding to a change in the solid shape 501. Moreover, the origin and reference axes of the real coordinate space are described as corresponding to the origin and reference axes of the target coordinate space. The origin of the real coordinate space may be the same as the origin or center of the solid shape 501. The origin of the target coordinate space may be the same as the origin or center of the virtual shape 507.

The processor may obtain the virtual shape 507, in which the solid shape 501 is expressed in three dimensions, by projecting the input image 503 into a target coordinate space including a first axis 510, a second axis 530, and a third axis 550 which are perpendicular to each other. Here, the origin of the virtual shape may be the same as the origin of the target coordinate space.

The processor may obtain first feature point coordinates and second feature point coordinates respectively corresponding to coordinates of the first feature point and the second feature point based on the solid shape 501 and the virtual shape 507. For example, the processor may obtain the coordinates of the first feature point, which is capable of being expressed in the virtual shape 507, based on the location of the first feature point on the surface of the solid shape 501. The processor may obtain the coordinates of the second feature point, which is capable of being expressed in the virtual shape 507, based on the location of the second feature point on the surface of the solid shape 501. That is, the first feature point coordinates may represent a location in the target coordinate space of the object expressed in the target coordinate space by the first feature point. The second feature point coordinates may represent a location in the target coordinate space of the object expressed in the target coordinate space by the second feature point.

The processor may rotate the solid shape 501 through a PLC output obtained by rotating the virtual shape 507 based on the first feature point coordinates and the second feature point coordinates. The PLC output may include signals capable of being applied to a device (e.g., a defect inspecting apparatus or inspection equipment) that rotates the solid shape 501. A device that rotates the solid shape 501 may rotate the solid shape 501 based on signals included in the PLC output.

For example, the PLC output obtained by rotating the virtual shape 507 in the target coordinate space by a second angle in the second direction with respect to an axis passing through the origin of the virtual shape 507 may include signals associated with a command for rotating the solid shape 501 by a second angle in the second direction with respect to an axis passing through the origin of the solid shape 501.

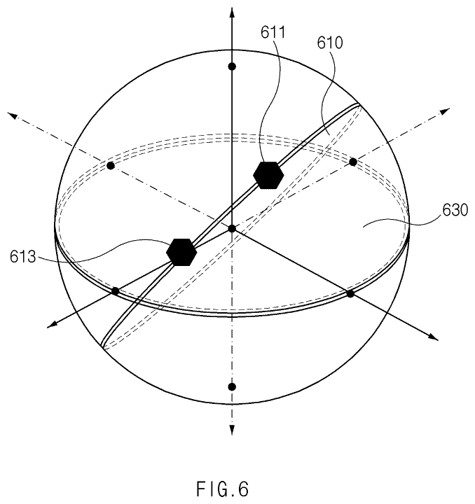

FIG. 6 is a diagram illustrating an example of feature point coordinates, according to an embodiment of the present disclosure.

According to an embodiment, a processor (e.g., the processor 110 of FIG. 1) may obtain first feature point coordinates 611 and second feature point coordinates 613 respectively corresponding to coordinates of a first feature point and a second feature point based on a virtual shape (e.g., the virtual shape 507 of FIG. 5) and a solid shape (e.g., the solid shape 501 of FIG. 5). For reference, the shape illustrated in FIG. 6 may represent the virtual shape 507.

The processor may obtain a first plane 610 passing through the first feature point coordinates 611, the second feature point coordinates 613, and the origin of the virtual shape 507.

The processor may rotate the solid shape 501 through a PLC output obtained by rotating the virtual shape 507 based on the first feature point coordinates 611 and the second feature point coordinates 613.

For example, the first feature point coordinates 611 and the second feature point coordinates 613 may correspond to the start text and the end text of the text formed on the surface of the solid shape 501. However, an embodiment is not limited thereto. The first feature point coordinates 611 and the second feature point coordinates 613 may correspond to at least one of predetermined text, a predetermined shape, or a predetermined form, or any combination thereof.

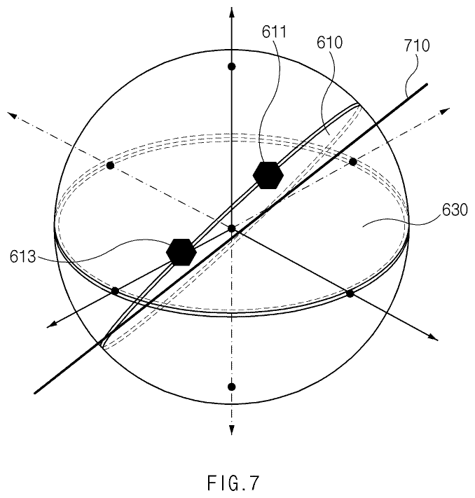

FIG. 7 is a drawing illustrating an example of an intersection that a first plane and a second plane have in common, according to an embodiment of the present disclosure.

According to an embodiment, a processor (e.g., the processor 110 of FIG. 1) may obtain an intersection 710 that the first plane 610 and a second plane 630 have in common. The second plane 630 may be determined based on a first axis (e.g., the first axis 510 of FIG. 5) and a second axis (e.g., the second axis 530 of FIG. 5).

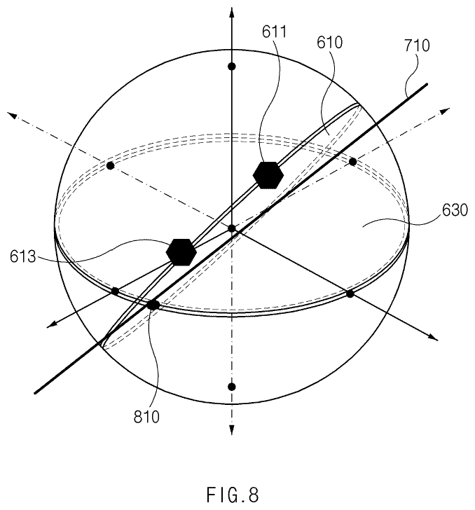

FIG. 8 is a diagram illustrating an example of first sub-coordinates, according to an embodiment of the present disclosure.

According to an embodiment of the present disclosure, a processor (e.g., the processor 110 of FIG. 1) may obtain the intersection 710 that the first plane 610 and the second plane 630 have in common, and first sub-coordinates 810 located on the surface of the virtual shape 507.

For example, the first sub-coordinates 810 may indicate a location of one of points that the intersection 710 and the surface of the virtual shape 507 have in common.

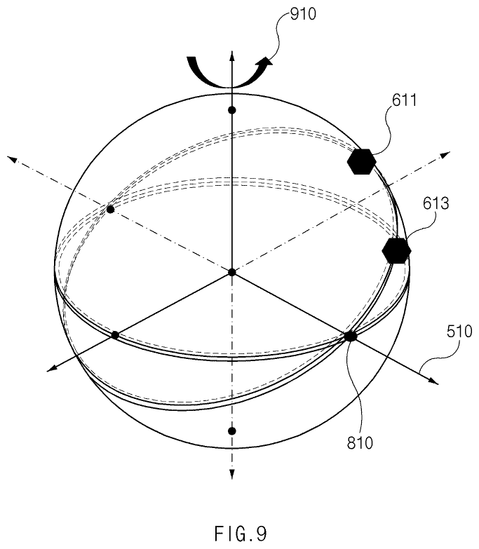

FIG. 9 is a diagram illustrating an example of first rotation of a virtual shape, according to an embodiment of the present disclosure.

According to an embodiment, a processor (e.g., the processor 110 of FIG. 1) may perform first rotation 910 of the virtual shape 507 such that the first sub-coordinates 810 are located on the first axis 510.

For example, the processor may obtain the PLC output by performing the first rotation 910 of the virtual shape 507. Here, the PLC output may include signals for performing the first rotation of the solid shape 501 based on the first rotation 910. The processor may perform the first rotation of the solid shape 501 based on the PLC output. As a result, locations of the first feature point and the second feature point of the solid shape 501 may correspond to the first feature point coordinates 611 and the second feature point coordinates 613 illustrated in FIG. 9.

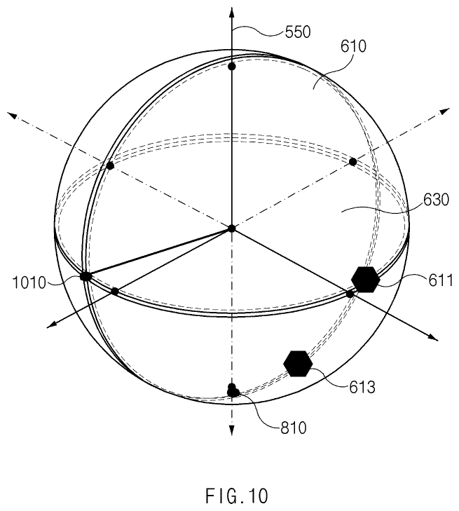

FIG. 10 is a diagram illustrating an example of second sub-coordinates, according to an embodiment of the present disclosure.

According to an embodiment, a processor (e.g., the processor 110 of FIG. 1) may rotate the virtual shape 507 such that the first sub-coordinates 810 are located on an axis perpendicular to the second plane 630. Here, the axis perpendicular to the second plane 630 may include the third axis 550. For reference, the virtual shape 507 illustrated in FIG. 10 may represent a state where the first sub-coordinates 810 are located on the third axis 550 perpendicular to the second plane 630.

For example, the processor may obtain a PLC output by rotating the virtual shape 507. Here, the PLC output may include signals for rotating the solid shape 501 based on the rotation where the first sub-coordinates 810 are located on an axis perpendicular to the second plane 630. The processor may rotate the solid shape 501 based on the PLC output. As a result, locations of the first feature point and the second feature point of the solid shape 501 may correspond to the first feature point coordinates 611 and the second feature point coordinates 613 illustrated in FIG. 10.

The processor may obtain second sub-coordinates 1010, which are a point located on the second plane 630 among points included in common in the first plane 610 and the surface of the virtual shape 507.

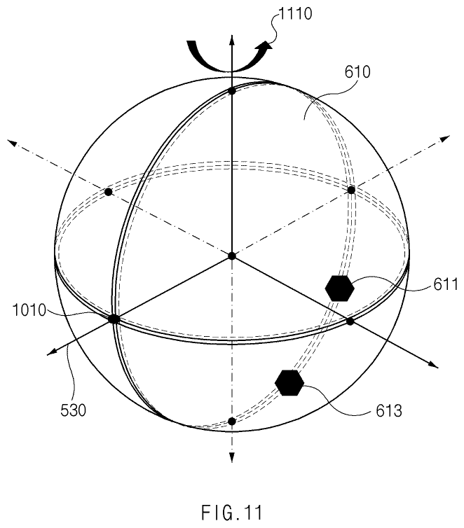

FIG. 11 is a diagram illustrating an example of second rotation of a virtual shape, according to an embodiment of the present disclosure.

According to an embodiment, a processor (e.g., the processor 110 of FIG. 1) may perform second rotation 1110 of the virtual shape 507 such that the second sub-coordinates 1010 are located on the second axis 530. For reference, the virtual shape 507 illustrated in FIG. 11 may represent a state where the second sub-coordinates 1010 are located on the second axis 530.

For example, the processor may obtain a PLC output by rotating the virtual shape 507. Here, the PLC output may include signals for rotating the solid shape 501 based on the rotation where the second sub-coordinates 1010 are located on the second axis 530. The processor may rotate the solid shape 501 based on the PLC output. As a result, locations of the first feature point and the second feature point of the solid shape 501 may correspond to the first feature point coordinates 611 and the second feature point coordinates 613 illustrated in FIG. 11.

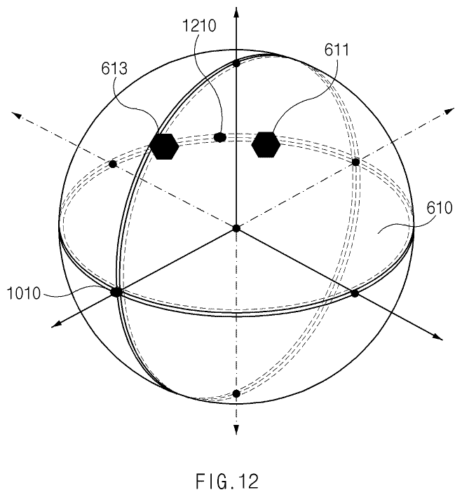

FIG. 12 is a diagram illustrating an example of third sub-coordinates, according to an embodiment of the present disclosure.

According to an embodiment, a processor (e.g., the processor 110 of FIG. 1) may rotate the virtual shape 507 by a predetermined angle (e.g., 90 degrees) with respect to the second axis 530. For reference, the virtual shape 507 illustrated in FIG. 12 may represent a state where the virtual shape 507 is rotated by a predetermined angle based on the second axis 530.

For example, the processor may obtain a PLC output by rotating the virtual shape 507. Here, the PLC output may include signals for rotating the solid shape 501 based on the rotation where the second sub-coordinates 1010 are located on the second axis 530. The processor may rotate the solid shape 501 based on the PLC output. As a result, locations of the first feature point and the second feature point of the solid shape 501 may correspond to the first feature point coordinates 611 and the second feature point coordinates 613 illustrated in FIG. 12.

The processor may obtain third sub-coordinates 1210 associated with a point having the same distance from each of the first feature point coordinates 611 and the second feature point coordinates 613 from among points included in common in the first plane 610 and the surface of the virtual shape 507.

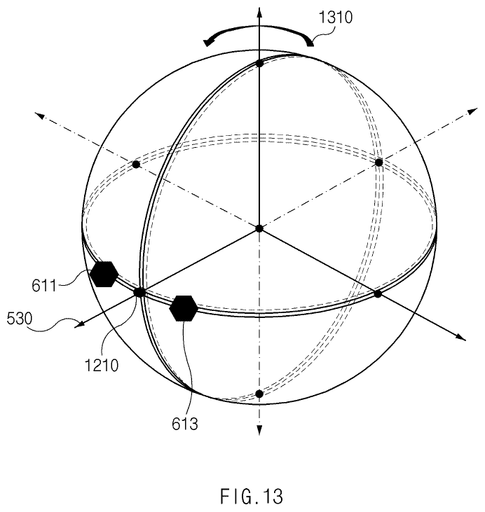

FIG. 13 is a diagram illustrating an example of third rotation of a virtual shape, according to an embodiment of the present disclosure.

According to an embodiment, a processor (e.g., the processor 110 of FIG. 1) may perform third rotation 1310 of the virtual shape 507 such that the third sub-coordinates 1210 are located on the second axis 530. For reference, the virtual shape 507 illustrated in FIG. 13 may represent a state where the third rotation 1310 of the virtual shape 507 is performed such that the third sub-coordinates 1210 are located on the second axis 530.

For example, the processor may obtain a PLC output by rotating the virtual shape 507. Here, the PLC output may include signals for rotating the solid shape 501 based on the third rotation 1310 of the virtual shape 507 such that the third sub-coordinates 1210 are located on the second axis 530. The processor may rotate the solid shape 501 based on the PLC output. As a result, locations of the first feature point and the second feature point of the solid shape 501 may correspond to the first feature point coordinates 611 and the second feature point coordinates 613 illustrated in FIG. 13.

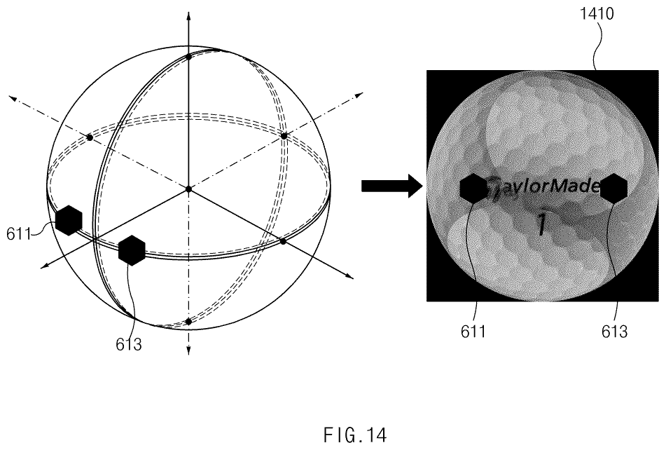

FIG. 14 is a diagram illustrating an example of a target image, according to an embodiment of the present disclosure.

According to an embodiment, a processor (e.g., the processor 110 of FIG. 1) may determine whether the first feature point coordinates 611 and the second feature point coordinates 613 are included in a target area, from the virtual shape 507 where the third sub-coordinates 1210 are located on the second axis 530. Here, the target area may include an area corresponding to a predetermined area in a target coordinate space.

When the first feature point coordinates 611 and the second feature point coordinates 613 are included in the target area, the processor may obtain a target image centered on the second axis 530 from the virtual shape 507. For example, the processor may obtain the target image centered on an axis corresponding to the second axis 530 from the solid shape 501 corresponding to the virtual shape 507 illustrated in FIG. 14. In other words, the axis corresponding to the second axis 530 in a real coordinate space may pass through the center of the camera (and/or lens) that photographs the solid shape 501.

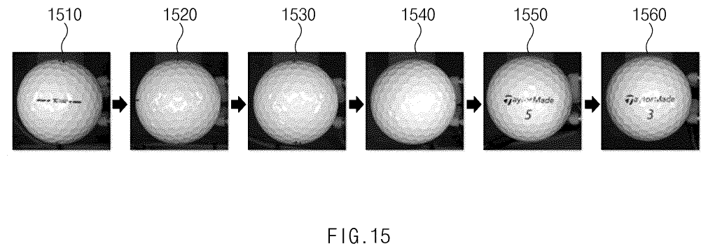

FIG. 15 is a drawing illustrating an example of rotation of a solid shape based on the virtual shapes of FIGS. 5 to 13, according to an embodiment of the present disclosure.

According to an embodiment, a processor (e.g., the processor 110 of FIG. 1) may rotate a solid shape through a PLC output obtained by rotating the virtual shape 507. The shape illustrated in FIG. 15 may represent a solid shape.

A state where rotation of the solid shape is not performed may be a first state 1510.

The processor may obtain a first plane passing through first feature point coordinates, second feature point coordinates, and the origin of the virtual shape 507. The processor may obtain the intersection that the first plane and a second plane have in common, and first sub-coordinates located on the surface of the virtual shape 507. The processor may perform first rotation of the virtual shape 507 such that the first sub-coordinates are located on a first axis. The processor may obtain a solid shape of a second state 1520 by rotating the solid shape based on a PLC output obtained through the first rotation. The detailed descriptions are given with reference to FIG. 9, and thus it may be omitted in FIG. 15.

The processor may rotate the virtual shape 507 such that the first sub-coordinates are located on an axis perpendicular to a second plane. The processor may obtain a solid shape of a third state 1530 by rotating the solid shape based on the PLC output obtained by rotating the virtual shape 507 such that the first sub-coordinates are located on the axis perpendicular to the second plane. The detailed descriptions are given with reference to FIG. 10, and thus it may be omitted in FIG. 15.

The processor may obtain second sub-coordinates, which are a point located on the second plane among points included in common in the first plane and the surface of the virtual shape 507. The processor may perform second rotation of the virtual shape 507 such that the second sub-coordinates are located on a second axis. The processor may obtain a solid shape of a fourth state 1540 by rotating the solid shape based on a PLC output obtained through the second rotation. The detailed descriptions are given with reference to FIG. 11, and thus it may be omitted in FIG. 15.

The processor may rotate the virtual shape 507 by a predetermined angle based on the second axis. The processor may obtain a solid shape of a fifth state 1550 by rotating the solid shape based on the PLC output obtained by rotating the virtual shape 507 by a predetermined angle. The detailed descriptions are given with reference to FIG. 12, and thus it may be omitted in FIG. 15.

The processor may obtain third sub-coordinates associated with a point having the same distance from each of the first feature point coordinates and the second feature point coordinates from among points included in common in the first plane and the surface of the virtual shape 507. The processor may perform third rotation of the virtual shape 507 such that the third sub-coordinates are located on the second axis. The processor may obtain a solid shape of a sixth state 1560 by rotating the solid shape based on a PLC output obtained through the third rotation. The detailed descriptions are given with reference to FIG. 13, and thus it may be omitted in FIG. 15.

The processor may obtain the target image based on the solid shape of the sixth state 1560. For example, the processor may obtain an image of the solid shape of the sixth state 1560. The processor may determine the obtained image as the target image.

FIG. 16 is a diagram illustrating an example of an interface for setting an area applied to an input image in a first image or a second image.

According to an embodiment, a processor (e.g., the processor 110 of FIG. 1) may execute a program including codes or instructions that perform the operations described with reference to FIGS. 2 to 15. Here, the program may be executed on any operating system environment (e.g., an environment of Windows).

The processor may obtain a first image associated with the surface of a solid shape based on a first rotation axis extending from the center of the solid shape. The processor may obtain a second image associated with the surface of a solid shape based on a second rotation axis perpendicular to the first rotation axis. The processor may obtain the input image 503 by combining the first image and the second image.

Referring to FIG. 16, an interface for setting the area of the first image or the second image is illustrated. For example, a user may set an area to be applied to the input image 503 through the interface illustrated in FIG. 16. In detail, the user may generate the input image 503 by combining the first image and the second image, whose areas are set, by setting the area of the first image or the second image.

For example, the user may set the area of the first image or the second image in a configuration window 1610. In detail, the user may input horizontal and vertical lines by dragging and dropping the mouse on the first image or the second image in the configuration window 1610. The processor may extract an area inside the horizontal and vertical lines when horizontal and vertical lines are input in the first image or the second image. The processor may determine the extracted area as the area to be applied to the input image 503.

For example, the horizontal line may represent a reference line extracted from the first image or the second image, within a range of 0 to 360 degrees relative to the surface of a solid shape. The vertical line may represent the reference line of the available area in the first image or the second image.

For example, when the user inputs the horizontal and vertical lines in the first image or the second image, the processor may provide the area inside the horizontal and vertical lines in an output window 1620. An image displayed in the output window 1620 may represent the image to be applied to the input image 503.

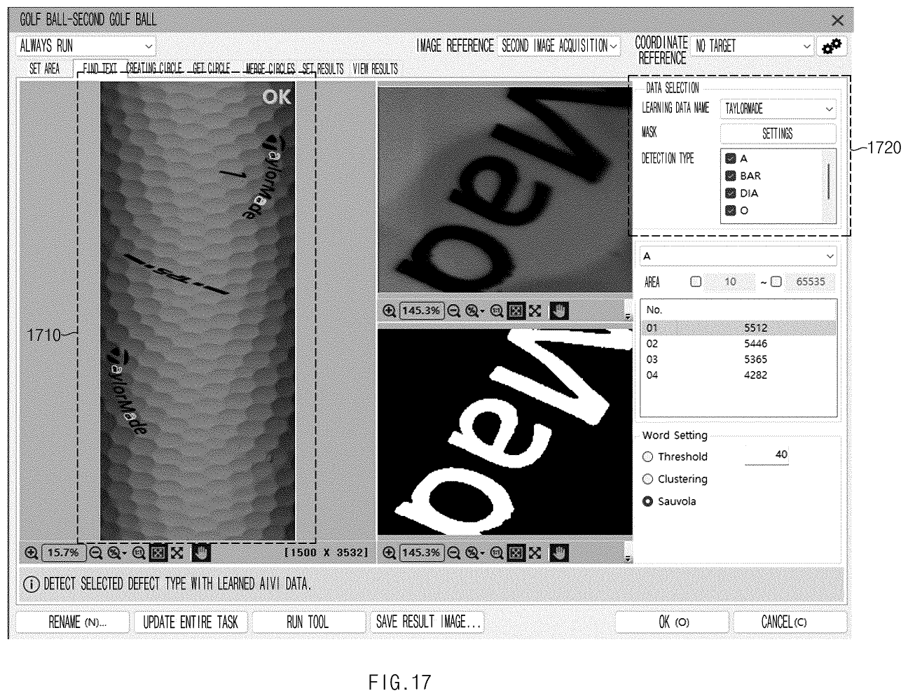

FIG. 17 is a diagram illustrating an example of an interface for obtaining feature points from a first image or a second image.

Referring to FIG. 17, FIG. 17 illustrates an interface for obtaining a feature point from an image. For example, the feature point may include a mark included on the surface of the solid shape (e.g., a spherical object).

Referring to an input window 1710, the input window 1710 may include an image displayed in an output window (e.g., the output window 1620 of FIG. 16). A configuration window 1720 may include a menu for setting a criterion for a feature point in an image. For example, the configuration window 1720 may include a learning data name, whether a mask is set, and a detection type (e.g., whether text ‘A’ is a feature point, or whether text ‘O’ is a feature point, or the like).

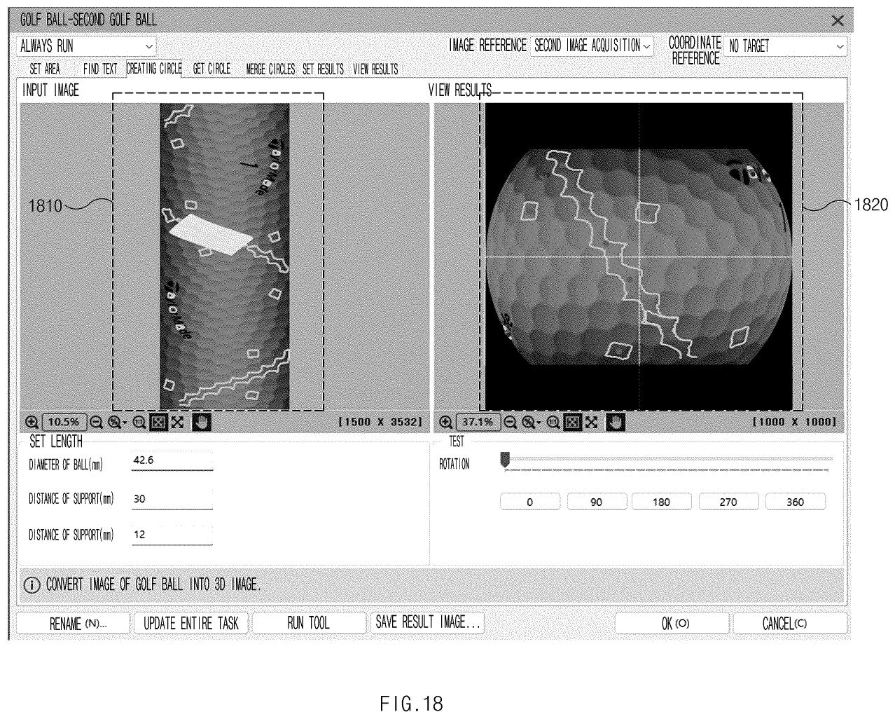

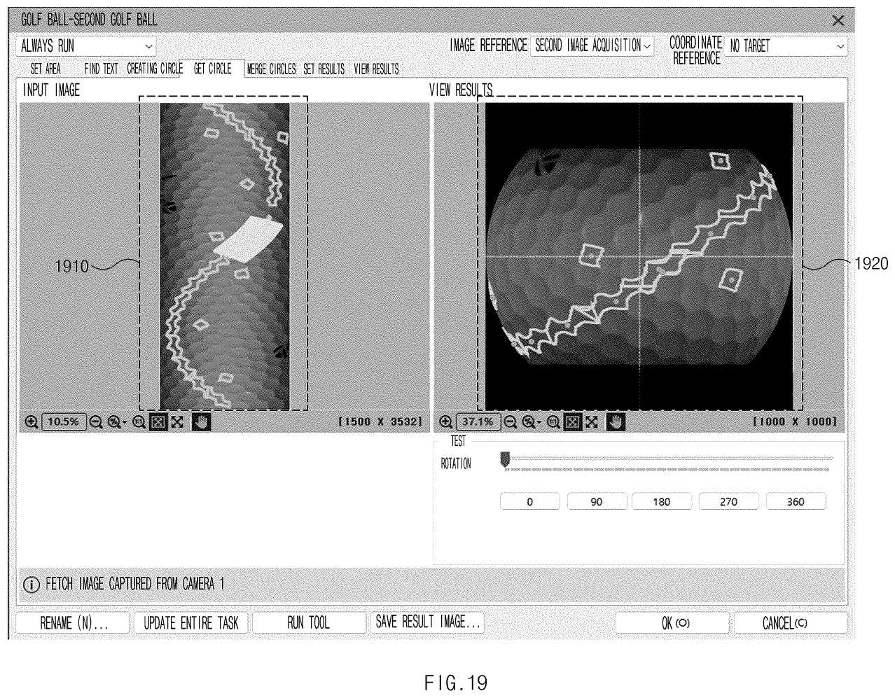

FIGS. 18 and 19 are diagrams showing examples of interfaces for converting a first image or a second image into a spherical image.

According to an embodiment, a processor (e.g., the processor 110 of FIG. 1) may convert a first image or a second image into a spherical image. The processor may obtain the input image 503 by combining the first image or the second image, which is converted into the spherical image.

For example, as described in FIG. 16, a horizontal line and a vertical line may be input onto the first image or the second image by a user. The processor may convert an area inside the horizontal line and the vertical line of the first image and the second image into the spherical image.

For example, an input window 1810 may output the area inside the horizontal line and the vertical line of the first image and the second image. An output window 1820 may output the result of converting the area inside the horizontal line and the vertical line of the first image and the second image into the spherical image.

For example, when an image shown in FIG. 18 is a first image, the processor may obtain the spherical image included in the output window 1820 by converting an image (i.e., the area inside the horizontal line and the vertical line of the first image) included in the input window 1810 into the spherical image. When an image shown in FIG. 19 is a second image, the processor may obtain the spherical image included in an output window 1920 by converting an image (i.e., the area inside the horizontal line and the vertical line of the second image) included in an input window 1910 into the spherical image.

For example, the processor may generate and/or obtain the input image 503 by combining the first image converted into the spherical image and the second image converted into the spherical image.

FIG. 20 is a diagram illustrating an example of an interface for obtaining an input image based on a first image and a second image.

According to an embodiment, a processor (e.g., the processor 110 of FIG. 1) may obtain the input image 503 by combining a first image converted into a spherical image and a second image converted into a spherical image.

For example, referring to FIG. 20, a first output window 2010 may output the first image converted into a spherical image. A second output window 2020 may output the second image converted to a spherical image. A third output window 2030 may output the input image 503 obtained by combining the first image converted into a spherical image and the second image converted into a spherical image.

For example, the processor may obtain a first feature point and a second feature point from the input image 503 output from the third output window 2030. The processor may obtain a target image, in which the first feature point and the second feature point are included in a predetermined area, by rotating a solid shape based on the first feature point and the second feature point and may obtain information about whether the solid shape has a defect, by applying the target image to a defect inspection model.

However, a method in which the processor obtains a feature point is not limited thereto. For example, the processor may obtain a feature point from the first image or the second image. The processor may obtain the feature point from the first image or the second image, and may obtain the input image 503 by combining the first image and the second image.

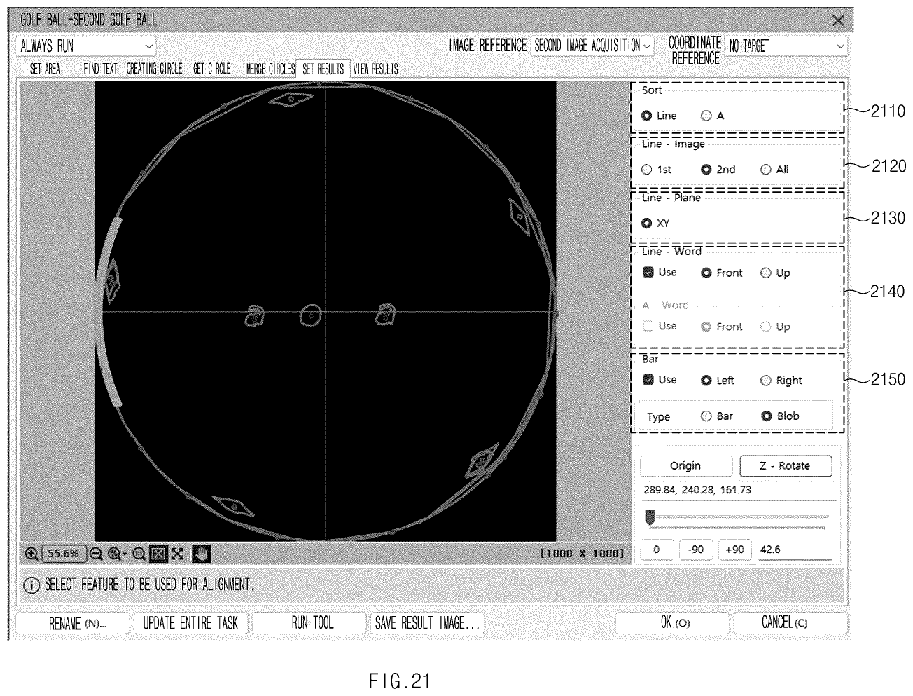

FIG. 21 is a diagram illustrating an example of an interface that receives an input for rotating a virtual shape corresponding to an input image.

Referring to FIG. 21, FIG. 21 illustrates an interface for receiving an input for rotating the virtual shape 507 corresponding to the input image 503.

For example, a first menu 2110 may provide a menu for setting a feature point that serves as the basis for rotation. A second menu 2120 may provide a menu for setting the type of the input image 503. A third menu 2130 may provide a menu for setting a rotation direction of the virtual shape 507. A fourth menu 2140 may provide a menu for setting the direction of line alignment (e.g., rotation of the virtual shape 507). A fifth menu 2150 may provide a menu for setting the alignment direction of text when a feature point is text.

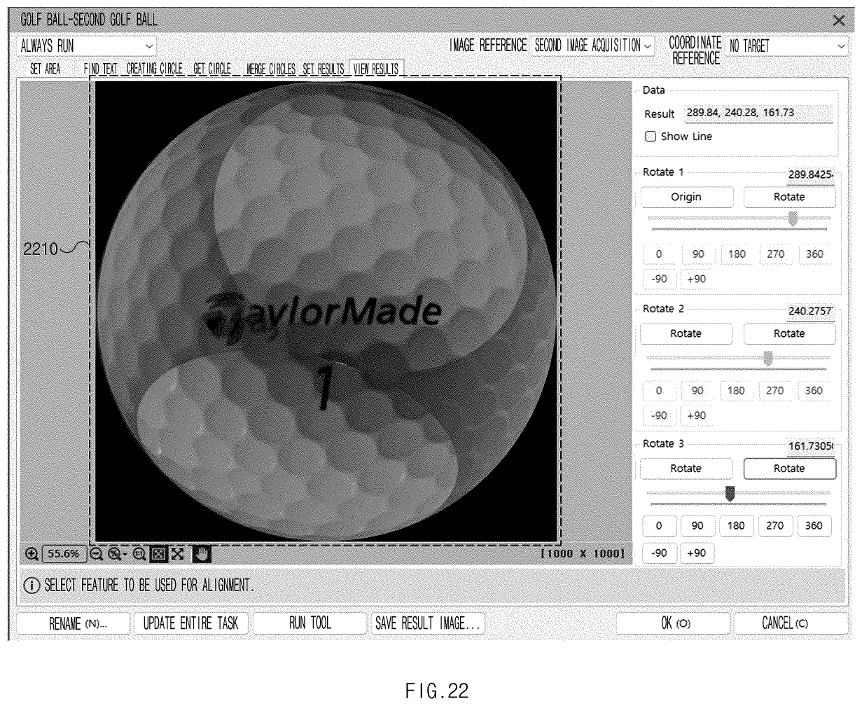

FIG. 22 is a diagram showing an example of an interface that outputs a target image.

Referring to FIG. 22, FIG. 22 illustrates an interface for outputting a target image.

For example, an output window 2210 may output a target image, in which the first feature point and the second feature point are included in a predetermined area, by rotating a solid shape based on the first feature point and the second feature point.

FIG. 23 is a diagram illustrating an example of an interface for generating learning data of a feature point identification model that identifies a feature point from an input image.

Referring to FIG. 23, FIG. 23 may illustrate an interface for generating learning data of a feature point identification model that identifies a feature point from the input image 503.

For example, the feature point identification model may include a neural network learned to extract a feature point (e.g., text) included in an image from an input image.

According to an embodiment, a processor (e.g., the processor 110 of FIG. 1) may learn the feature point identification model. The learning may be performed in the defect inspecting apparatus (e.g., the defect inspecting apparatus 100 of FIG. 1), in which the feature point identification model is performed, or may be performed through a separate server (e.g., the server 140 of FIG. 1). The feature point identification model in which the learning is completed may be stored in a memory (e.g., the memory 120 in FIG. 1).

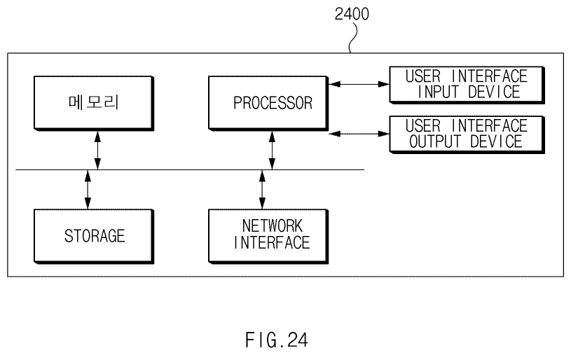

FIG. 24 is a diagram illustrating a computing system associated with a defect inspecting apparatus or a defect inspecting method, according to an embodiment of the present disclosure.

Referring to FIG. 24, a computing system 2400 associated with a defect inspecting apparatus or a defect inspecting method may include at least one processor, a memory, a user interface input device, a user interface output device, storage, and a network interface, which are connected with each other via a bus.

The processor may be a central processing unit (CPU) or a semiconductor device that processes instructions stored in the memory and/or the storage. The memory and the storage may include various types of volatile or nonvolatile storage media. For example, the memory may include a read only memory (ROM) and a random access memory (RAM).

Accordingly, the operations of the method or algorithm described in connection with the embodiments disclosed in the specification may be directly implemented with a hardware module, a software module, or a combination of the hardware module and the software module, which is executed by the processor. The software module may reside on a storage medium (i.e., the memory and/or the storage) such as a random access memory (RAM), a flash memory, a read only memory (ROM), an erasable and programmable ROM (EPROM), an electrically EPROM (EEPROM), a register, a hard disk drive, a removable disc, or a compact disc-ROM (CD-ROM).

The exemplary storage medium may be coupled to the processor. The processor may read out information from the storage medium and may write information in the storage medium. Alternatively, the storage medium may be integrated with the processor. The processor and the storage medium may be implemented with an application specific integrated circuit (ASIC). The ASIC may be provided in a user terminal. Alternatively, the processor and the storage medium may be implemented with separate components in the user terminal.

The above description is merely an example of the technical idea of the present disclosure, and various modifications and variations may be made by one skilled in the art without departing from the essential characteristic of the present disclosure.

The above-described embodiments may be implemented with hardware elements, software elements, and/or a combination of hardware elements and software elements. For example, the devices, methods, and components described in embodiments of the present disclosure may be implemented by using general-use computers or special-purpose computers, such as a processor, a controller, an arithmetic logic unit (ALU), a digital signal processor, a microcomputer, a field programmable array (FPA), a programmable logic unit (PLU), a microprocessor, or any device which may execute instructions and respond. A processing device may perform an operating system (OS) or a software application running on the OS. Further, the processing device may access, store, manipulate, process and generate data in response to execution of software. It will be understood by those skilled in the art that although a single processing device may be illustrated for convenience of understanding, the processing device may include a plurality of processing elements and/or a plurality of types of processing elements. For example, the processing device may include a plurality of processors or one processor and one controller. Also, the processing device may include a different processing configuration, such as a parallel processor.

Software may include computer programs, codes, instructions or one or more combinations thereof and configure a processing device to operate in a desired manner or independently or collectively control the processing device. Software and/or data may be permanently or temporarily embodied in any type of machine, components, physical equipment, virtual equipment, computer storage media or units or transmitted signal waves so as to be interpreted by the processing device or to provide instructions or data to the processing device. Software may be dispersed throughout computer systems connected over networks and be stored or executed in a dispersion manner. Software and data may be recorded in a computer-readable storage medium.

The methods according to the above-described embodiments may be recorded in a computer-readable medium including program instructions that are executable through various computer devices. The computer-readable medium may also include program instructions, data files, data structures, and the like, singly or in combination. The program instructions recorded in the medium may be designed and configured specially for the embodiments of the present disclosure or may be known and available to those skilled in computer software. The computer-readable medium may include hardware devices, which are specially configured to store and execute program instructions, such as magnetic media (e.g., a hard disk, a floppy disk, or a magnetic tape), optical recording media (e.g., CD-ROM and DVD), magneto-optical media (e.g., a floptical disk), read only memories (ROMs), random access memories (RAMs), and flash memories. Examples of computer programs include not only machine language codes created by a compiler, but also high-level language codes that are capable of being executed by a computer by using an interpreter or the like.

The hardware device described above may be configured to act as one or more software modules to perform the operations of the above-described embodiments of the present disclosure, or vice versa.

Even though the embodiments are described with reference to restricted drawings, it may be obvious to one skilled in the art that the embodiments are variously changed or modified based on the above description. For example, adequate effects may be achieved even though the foregoing processes and methods are carried out in different order than described above, and/or the aforementioned elements, such as systems, structures, devices, or circuits, are combined or coupled in different forms and modes than as described above or be substituted or switched with other components or equivalents.

Therefore, other implements, other embodiments, and equivalents to claims are within the scope of the following claims.

Accordingly, embodiments of the present disclosure are intended not to limit but to explain the technical idea of the present disclosure, and the scope and spirit of the present disclosure is not limited by the above embodiments. The scope of protection of the present disclosure should be construed by the attached claims, and all equivalents thereof should be construed as being included within the scope of the present disclosure.

Descriptions of a defect inspecting apparatus according to an embodiment of the present disclosure, and a method thereof are as follows.

Moreover, according to at least one of embodiments of the present disclosure, a defect inspecting apparatus obtains whether a solid shape has a defect, by applying a target image, which is obtained by rotating a solid shape based on an input image of a solid shape to be subject to defect inspection, to a defect inspection model, thereby reducing the possibility that a minute surface defect may affect a trajectory, along which the solid shape moves, through precise inspection.

In addition, a variety of effects directly or indirectly understood via the present disclosure may be provided.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A defect inspecting apparatus comprising:
a memory configured to store computer-executable instructions; and
at least one processor configured to execute the instructions by accessing the memory,
wherein the at least one processor is configured to:
obtain a first feature point and a second feature point, which serve as a basis for rotation of a solid shape, from an input image associated with the solid shape targeted for defect inspection;
obtain a target image, in which the first feature point and the second feature point are included in a predetermined area, by rotating the solid shape based on the first feature point and the second feature point; and
obtain information about whether the solid shape has a defect, by applying the target image to a defect inspection model.

2. The defect inspecting apparatus of claim 1, wherein the at least one processor is configured to:
obtain a virtual shape, in which the solid shape is expressed in three dimensions, by projecting the input image into a target coordinate space including a first axis, a second axis, and a third axis, which are perpendicular to each other, wherein an origin of the virtual shape is the same as an origin of the target coordinate space;
obtain first feature point coordinates and second feature point coordinates respectively corresponding to coordinates of the first feature point and the second feature point based on the virtual shape and the solid shape; and
rotate the solid shape through a programmable logic controller (PLC) output obtained by rotating the virtual shape based on the first feature point coordinates and the second feature point coordinates.

3. The defect inspecting apparatus of claim 2, wherein the at least one processor is configured to:
obtain a first plane passing through the first feature point coordinates, the second feature point coordinates, and the origin of the virtual shape;
obtain an intersection that the first plane and a second plane have in common, and first sub-coordinates located on a surface of the virtual shape, wherein the second plane is determined based on the first axis and the second axis; and
perform first rotation of the virtual shape such that the first sub-coordinates are located on the first axis.

4. The defect inspecting apparatus of claim 3, wherein the at least one processor is configured to:
rotate the virtual shape such that the first sub-coordinates are located on an axis perpendicular to the second plane, wherein the axis perpendicular to the second plane includes the third axis;
obtain second sub-coordinates, which are a point located on the second plane among points included in common in the first plane and the surface of the virtual shape; and
perform second rotation of the virtual shape such that the second sub-coordinates are located on the second axis.

5. The defect inspecting apparatus of claim 4, wherein the at least one processor is configured to:
rotate the virtual shape by a predetermined angle based on the second axis;
obtain third sub-coordinates associated with a point having the same distance from each of the first feature point coordinates and the second feature point coordinates from among points included in common in the first plane and the surface of the virtual shape; and
perform third rotation of the virtual shape such that the third sub-coordinates are located on the second axis.

6. The defect inspecting apparatus of claim 5, wherein the at least one processor is configured to:
determine whether the first feature point coordinates and the second feature point coordinates are included in a target area, from the virtual shape where the third sub-coordinates are located on the second axis, wherein the target area includes an area corresponding to the predetermined area in the target coordinate space; and
obtain the target image centered on the second axis from the virtual shape when the first feature point coordinates and the second feature point coordinates are included in the target area.

7. The defect inspecting apparatus of claim 1, wherein the at least one processor is configured to:
obtain a first image associated with a surface of the solid shape based on a first rotation axis extending from a center of the solid shape;
obtain a second image associated with the surface of the solid shape based on a second rotation axis perpendicular to the first rotation axis; and
obtain the input image by combining the first image and the second image.

8. The defect inspecting apparatus of claim 1, wherein the defect inspection model includes a neural network pre-learned to extract a defect in a target included in an image from an image thus input.

9. The defect inspecting apparatus of claim 1, wherein the solid shape includes a spherical object, and
wherein the first feature point and the second feature point include a mark included on a surface of the spherical object.

10. A defect inspecting method comprising:
obtaining a first feature point and a second feature point, which serve as a basis for rotation of a solid shape, from an input image associated with the solid shape targeted for defect inspection;
obtaining a target image, in which the first feature point and the second feature point are placed in a predetermined area, by rotating the solid shape based on the first feature point and the second feature point; and
obtaining information about whether the solid shape has a defect, by applying the target image to a defect inspection model.
